(19) United States
(12) Patent Application Publication
(10) Pub. No.: US 2016/0125454 A1
(43) Pub. Date: May 5, 2016

(54) SYSTEMS AND METHODS FOR MANAGING ADVERTISING CAMPAIGNS

(71) Applicant: Yahoo! Inc., Sunnyvale, CA (US)

(72) Inventors: Howard Karloff, New York, NY (US); Yifan Hu, Mountain Lakes, NJ (US); Jeremy Kanterman, Scotch Plains, NJ (US); Pengyuan WANG, Sunnyvale, CA (US); Shahriyar Sufi, Chicago, IL (US)

(73) Assignee: YAHOO! INC., Sunnyvale, CA (US)

(21) Appl. No.: 14/532,831

(22) Filed: Nov. 4, 2014

(51) Int. Cl. G06Q 30/02

(52) U.S. Cl. CPC G06Q 30/0249

(57) ABSTRACT

Systems and methods for managing advertisement campaign are provided. The system includes one or more devices having a processor and a non-transitory storage medium accessible to the hardware processor. The system includes a memory storing a database including campaign data. The system also includes a server computer in communication with the database. The server computer is programmed to receive a budget to be spent on a plurality of websites. The server computer is programmed to estimate a parameter for a non-linear model based on the campaign data. The server computer is programmed to estimate an expected number of conversions for each of the plurality of websites using the non-linear model with the estimated parameter. The server computer is programmed to determine an allocation of impressions for the plurality of websites that maximizes an estimated total number of conversions.

### BACKGROUND

The Internet is a ubiquitous medium of communication in most parts of the world. The emergence of the Internet has opened a new forum for the creation and placement of advertisements (ads) promoting products, services, and brands. Internet content providers rely on advertising revenue to drive the production of free or low cost content. Advertisers, in turn, increasingly view Internet content portals and online publications as a critically important medium for the placement of advertisements.

There are various advertising opportunities nowadays, including advertising associated with user search queries, non-sponsored search advertising, graphical or display advertising, video advertising, and mobile advertising. The nature of Internet communication enables advertisers and content providers to target advertising campaigns to viewers through different advertising channels to increase conversion. Advertisers may pay for the display of an advertisement to a viewer. For example, an advertiser may pay for each advertisement impression on a web page, a user clicking on an advertisement, or for a conversion of a product or service associated with the advertisement. At the same time, the advertiser may pay for other types of advertisement through similar arrangements on different platforms. However, the existing technology does not provide a solution to the advertisers on how to spend their advertising budget on different platforms.

Thus, there is a need to develop methods and systems that provide advertisers with the solution to solve the above problem.

### SUMMARY

Different from conventional solutions, the disclosed system solves the above problem by building a computer system based on multitouch attribution of pay-per-conversion advertising.

In a first aspect, the embodiments disclose a computer system that includes one or more devices having a processor and a non-transitory storage medium accessible to the hardware processor. The system includes a memory storing a database comprising campaign data. The system also includes a server computer in communication with the database. The server computer is programmed to receive a budget to be spent on a plurality of websites. The server computer is programmed to estimate a parameter for a non-linear model based on the campaign data. The server computer is programmed to estimate an expected number of conversions for each of the plurality of websites using the non-linear model with the estimated parameter. The server computer is programmed to determine an allocation of impressions for the plurality of websites that maximizes an estimated total number of conversions.

In a second aspect, the embodiments disclose a computer implemented method by a system that includes one or more devices having a processor. In the computer implemented method, the system records campaign data during a first time period in a database. The system receives a budget to be spent on a plurality of placements during a second time period. The system obtains a non-linear model based on the campaign data. The system estimates an expected number of conversions during the second time period for each of the plurality of placements using the non-linear model. The system also allocates the budget to the plurality of placements that maximizes an estimated total number of conversions from the plurality of placements.

In a third aspect, the embodiments disclose a non-transitory storage medium configured to store a set of modules. The non-transitory storage medium includes module for recording campaign data in a database, where the campaign data include: a number of cumulative impressions of a recent campaign and conversion history of the recent campaign. The non-transitory storage medium further includes a module for receiving a budget to be spent on a plurality of future campaigns; a module for estimating a parameter for a non-linear model based on the campaign data; a module for estimating an expected number of conversions for each of the plurality of future campaigns using the non-linear model with the estimated parameter; and a module for determining an allocation of impressions for the plurality of future campaigns that maximizes an estimated total number of conversions from the plurality of future campaigns.

### BRIEF DESCRIPTION OF THE DRAWINGS

FIG. 1 is a block diagram of an example environment in which a computer system according to one embodiment of the disclosure may operate;

FIG. 2 illustrates an example computing device in the computer system for interacting with the advertiser;

FIG. 3 illustrates an example embodiment of a server computer for budget allocation;

FIG. 4 is an example block diagram illustrating embodiments of the non-transitory storage of the server computer;

FIG. 5A is an example block diagram illustrating embodiments of the disclosure; and

FIG. 5B is an example block diagram illustrating embodiments of the disclosure.

### DETAILED DESCRIPTION OF THE DRAWINGS

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

For web portals like Yahoo!, advertisements may be displayed on different platforms or websites. For example, an advertiser may choose to display advertisements on Yahoo! Finance, Yahoo! Movies, Flickr, Tumblr, Yahoo! Mail, mobiles applications by Yahoo!, and other affiliated websites or platforms. In this case, the advertiser would want to know how best to spend his or her money on different websites and platforms. In other words, the advertiser would want to know how to reach his campaign goal with the limited budget. The disclosure provides a system that solves the budget allocation problem.

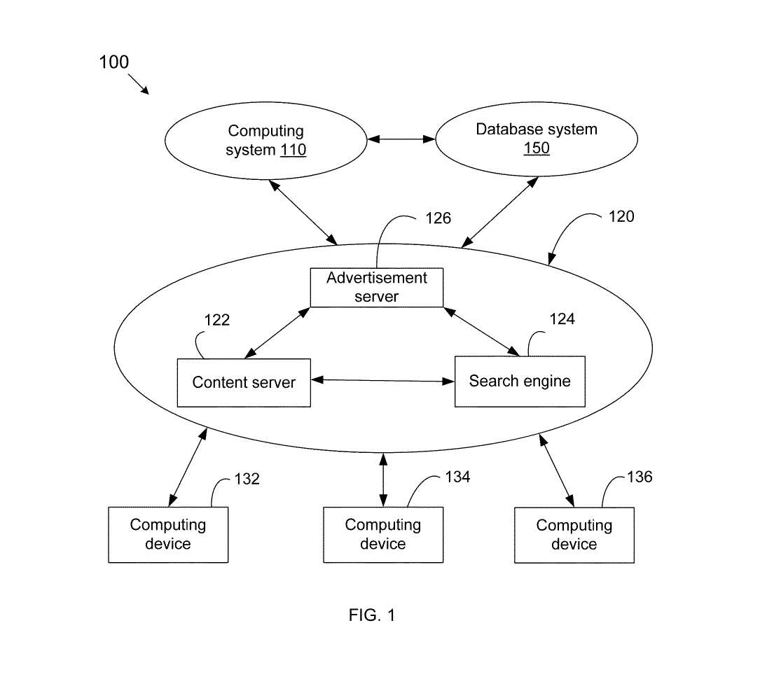

FIG. 1 is a block diagram of one embodiment of an environment 100 in which a system for budget allocation. However, it should be appreciated that the systems and methods described below are not limited to use with the particular exemplary environment 100 shown in FIG. 1 but may be extended to a wide variety of implementations.

The environment 100 may include a computing system 110 and a connected server system 120 including a content server 122, a search engine 124, and an advertisement server 126. The computing system 110 may include a cloud computing environment or other computer servers. The server system 120 may include additional servers for additional computing or service purposes. For example, the server system 120 may include servers for social networks, online shopping sites, and any other online services.

The content server 122 may be a computer, a server, or any other computing device known in the art, or the content server 122 may be a computer program, instructions, and/or software code stored on a computer-readable storage medium that runs on a processor of a single server, a plurality of servers, or any other type of computing device known in the art. The content server 122 delivers content, such as a web page, using the Hypertext Transfer Protocol and/or other protocols. The content server 122 may also be a virtual machine running a program that delivers content.

The search engine 124 may be a computer system, one or more servers, or any other computing device known in the art, or the search engine 124 may be a computer program, instructions, and/or software code stored on a computer-readable storage medium that runs on a processor of a single server, a plurality of servers, or any other type of computing device known in the art. The search engine 124 is designed to help users find information located on the Internet or an intranet.

The advertisement server 126 may be a computer system, one or more computer servers, or any other computing device known in the art, or the advertisement server 126 may be a computer program, instructions and/or software code stored on a computer-readable storage medium that runs on a processor of a single server, a plurality of servers, or any other type of computing device known in the art. The advertisement server 126 is designed to provide digital ads to a web user based on display conditions requested by the advertiser. The advertisement server 126 may include computer servers for providing ads to different platforms and websites.

The computing system 110 and the connected server system 120 have access to a database system 150. The database system 150 may include one or more databases. At least one of the databases in the database system may be a user database that stores information related to a plurality of users. The user database may be organized on a user-by-user basis such that each user has a unique record file. The record file may include all information related to a specific user from all data sources. For example, the record file may include personal information of the user, search histories of the user from the search engine 124, web browsing histories of the user from the content server 122, or any other information available to a service provider that is affiliated with the computer server system 120.

The environment 100 may further include a plurality of computing devices 132, 134, and 136. The computing devices may be a computer, a smart phone, a personal digital aid, a digital reader, a Global Positioning System (GPS) receiver, or any other device that may be used to access the Internet.

The disclosed system and method for budget allocation may be implemented by the computing system 110. Alternatively or additionally, the system and method for budget allocation may be implemented by one or more of the servers in the server system 120. The disclosed system may instruct the computing devices 132, 134, and 136 to display all or part of the user interfaces to request input from the advertisers. The disclosed system may also instruct the computing devices 132, 134, and 136 to display all or part of the allocation recommendations to the advertisers.

Generally, an advertiser or any other user may use a computing device such as computing devices 132, 134, and 136 to access information on the server system 120. The advertiser may want to identify a target audience for his/her product or services. Based on the target audience and the products, the advertiser may select a plurality of websites and platforms for the campaign. The advertiser may have a total budget to spend on the plurality of websites and platforms. The disclosed system then can help the advertiser to decide how much budget to spend on the different websites and platforms. The system may give the advertiser an allocation in terms of dollar numbers or impression numbers on each website and each platform.

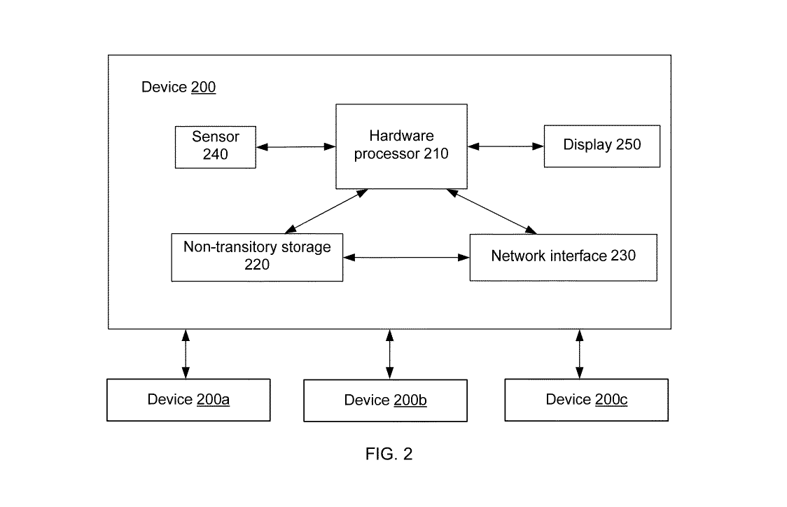

FIG. 2 illustrates an example computing device 200 for interacting with the advertiser. The computing device 200 may be a computer, a smartphone, a server, a terminal device, or any other computing device including a hardware processor 210, a non-transitory storage medium 220, and a network interface 230. The hardware processor 210 accesses the programs and data stored in the non-transitory storage medium 220. The device 200 may further include at least one sensor 240, circuits, and other electronic components. The device may communicate with other devices 200a, 200b, and 200c via the network interface 230. The computing device 200 may display user interfaces on a display unit 250. For example, the computing device 200 may display a user interface on the display unit 250 asking the advertiser to input the total amount of budget. The computing device 200 may further display the budget allocation using figures or drawings which may be easily understood by the advertiser.

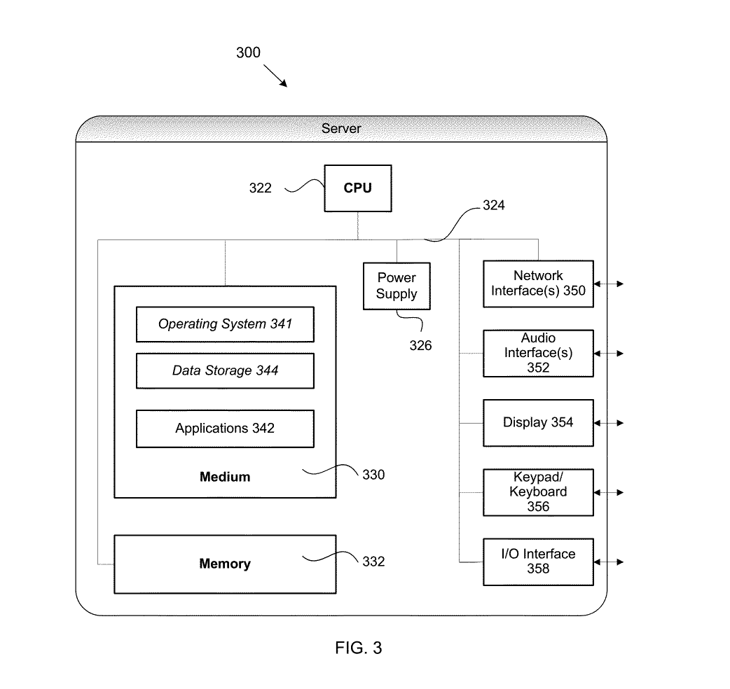

FIG. 3 is a schematic diagram illustrating an example embodiment of a server. A Server 300 may include different hardware configurations or capabilities. For example, a server 300 may include one or more central processing units 322, memory 332 that is accessible to the one or more central processing units 322, one or more medium 630 (such as one or more mass storage devices) that store application programs 342 or data 344, one or more power supplies 326, one or more wired or wireless network interfaces 350, one or more input/output interfaces 358. The memory 332 may include non-transitory storage memory and transitory storage memory.

A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as any server shown in FIG. 1. The server 300 may also serve as a computer server that implements the budget allocation system. In either case, the server 300 is in communication with a database that stores campaign data. For example, the server 300 may record the campaign data including: a number of cumulative impressions of a recent campaign, conversion history of the recent campaign, and cost per mille (CPM) of each placement in an upcoming campaign. The server 300 may record the above data for each campaign so that all the campaign data may be used to estimate parameters using regression models. The server 300 may divide the campaign data according to industries, products, user groups, or other characteristics of the campaign so that the estimation may be more accurate for each different type of campaign.

For example, the server 300 may track each impression to each user so that the server 300 records the total number of impressions a user had before a conversion. The server 300 can then credit each impression with appropriate credit for that final conversion. The server 300 may track all user activities on different platforms so that the impressions on different platforms could be credited if a conversion activity is performed. The server 300 may use cookies or other technology to track user activities and impressions. The user may be able to opt out regarding to activity tracking. The different platforms may include Internet ads, TV ads, ads in games, mobile ads, etc.

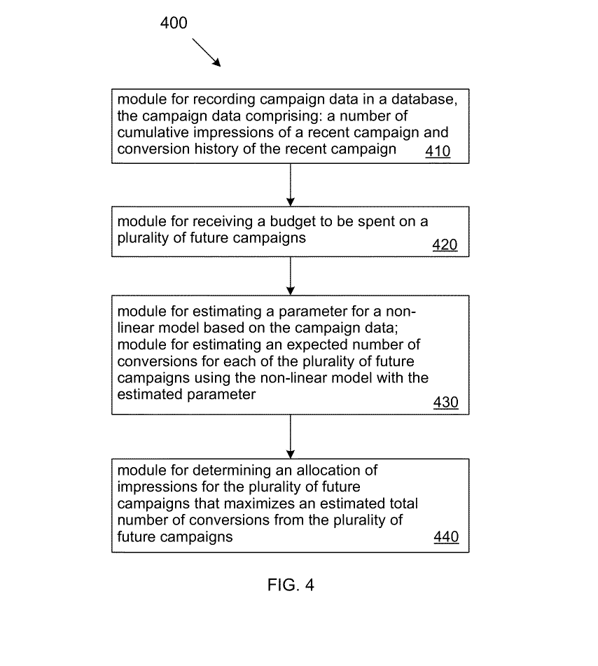

FIG. 4 illustrates embodiments of a non-transitory storage medium in the server 300 illustrated in FIG. 3. The non-transitory storage medium 400 includes module for recording campaign data in a database. The campaign data includes: a number of cumulative impressions of a recent campaign and conversion history of the recent campaign. The different platforms and websites may perform differently for different campaigns. The recorded data help the computer system to understand the differences and estimate model parameters so that future campaign budget can be spent more effectively to attract more attention or obtain more conversions. The module may include sub-modules in one or more computer servers.

The non-transitory storage medium 400 includes module for receiving a budget to be spent on a plurality of future campaigns. The computer server may need to ask the advertiser whether the advertiser prefer running a budget allocation for more effective campaign. The computer server may also set up a threshold such that the question to the advertiser only prompts when the budget is greater than the threshold.

The non-transitory storage medium 400 includes module for estimating a parameter for a non-linear model based on the campaign data. The computer server may provide one or more models for the advertiser to choose before training the model. The computer server may provide those models based on information about the advertisement and information about the advertiser. The model may be non-linear model or linear model or a combination of both. For example, the non-linear model may model a reach per future campaign as a polynomial function C^{α}, where C is the cumulative number of impressions and α is the estimated parameter for the non-linear model. The non-linear model may have other explicit expression such as β(C/(C+λ)), in which there are two parameters β and λ need to be estimated. The computer server may estimate the one or more parameters of the non-linear model based on the campaign data using regression analysis.

The non-transitory storage medium 400 includes module for estimating an expected number of conversions for each of the plurality of future campaigns using the non-linear model with the estimated parameter. Based on the model, the computer server may then estimate the number of conversions for each future campaign. The estimation may be implemented in a computer system that runs simulations based on the model parameters and characteristics of different websites and platforms. Each different platform or website may have different models and/or different model parameters for different campaigns.

The non-transitory storage medium 400 includes module for determining an allocation of impressions for the plurality of future campaigns that maximizes an estimated total number of conversions from the plurality of future campaigns. Using the estimated number of conversions, the computer server may determine how to allocate the budget to different platforms and websites using computer algorithms implemented in computer servers or clusters. One of the algorithms that may be used is based on convex optimization.

The algorithm minimizes convex functions over convex sets. For example, the algorithm may be implemented using the Python programming language. The software package can then be used with the interactive Python interpreter, on the command line by executing Python scripts, or integrated in other software via Python extension modules. Thus, system and methods for budget allocation may be built on Python's extensive standard library and on the strengths of Python as a high-level programming language. Alternatively or additionally, the system and methods may be implemented using other computer languages. The results of the algorithm may need a computer to interpret so that the advertiser can understand by viewing the results on a display unit of the computer server or a terminal device.

The non-transitory storage medium 400 may further include module for estimating the expected number of conversions for each of the plurality of future campaigns as a non-linear function. The non-linear function may include a polynomial function, a rational function, or a combination of both. A first example of the non-linear function is b*X^{α}, where b is a normalization factor, X is a number of impressions to be purchased, and a is the estimated parameter for the non-linear model. A second example of the non-linear function is a rational function such as b*(X/(X+λ)), where X is a number of impressions to be purchased, and b and λ are the estimated parameters using regression analysis. The estimation generally cannot be derived in human minds due to the amount of data involved and the complexity of the estimation problem.

The non-transitory storage medium 400 may further include module for determining the allocation of impressions using convex optimization that maximizes

$${\sum }_{1}^{N} {b}_{i} {X}_{i}^{{α}_{i}}$$

while keeping an actual budget less than or equal to the budget to be spent on the plurality of future campaigns. Here bᵢ is a normalization factor for each future campaign, Xᵢ is a number of impressions to be purchased for website i, αᵢ is the estimated parameter for the non-linear model for website i, and N is a total number of future placements of the plurality of future placements. Alternatively, when the non-linear function is modeled as b*(X/(X+λ)), the target function to be maximized may have the format of

$${\sum }_{1}^{N} {b}_{i} {X}_{i} \text{/} ( {X}_{i} + {λ}_{i} ) .$$

Here, a campaign may refer to an advertisement campaign on a particular website or a particular publisher, etc. Generally, a publisher such as Yahoo may have many advertising placements, such as the Yahoo Finance site, Yahoo Sports, Yahoo Screen, etc. The disclosed system and method may allocate budget across different advertising placements in multiple publishers or allocate budget across different advertising placements in one publisher.

The non-transitory storage medium 400 may include modules for displaying the user interfaces and allocation results. The non-transitory storage medium 400 may include additional modules to facilitate user interactions and communications between different computing devices.

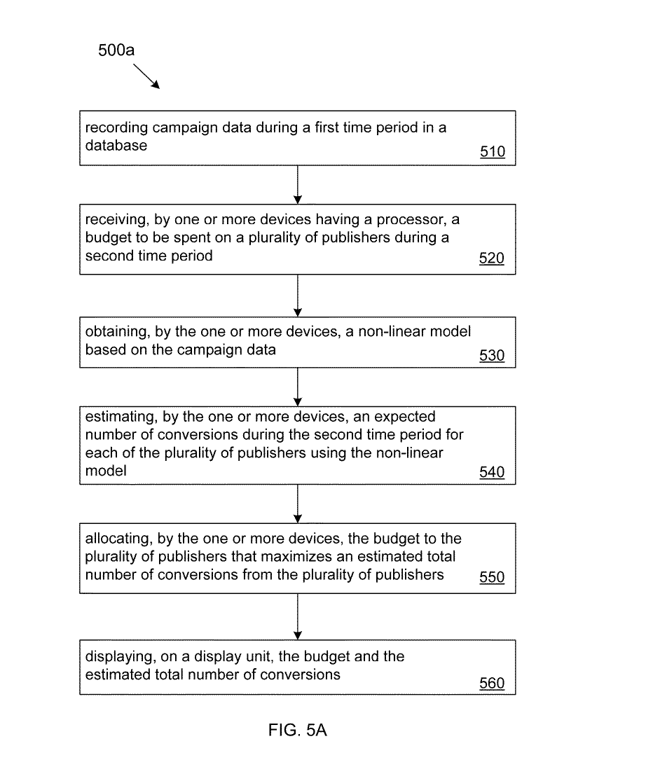

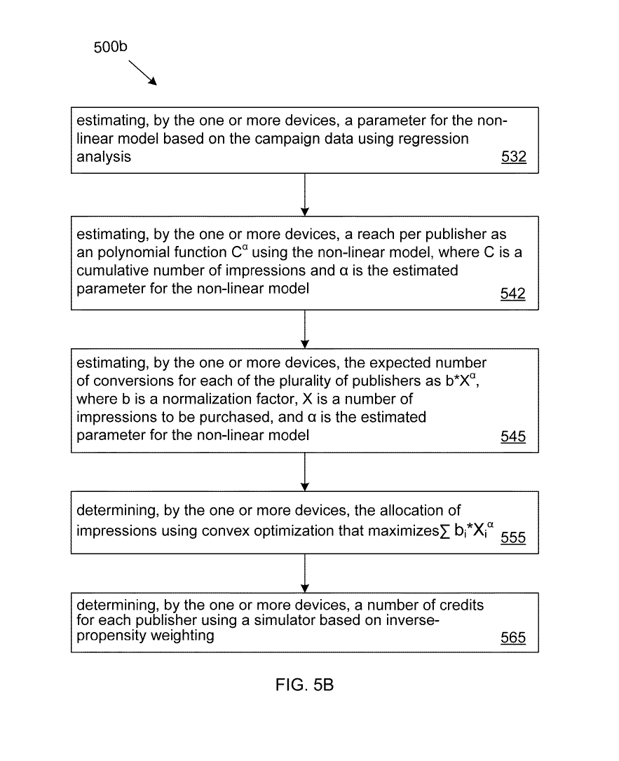

FIG. 5A is an example block diagram 500a illustrating embodiments of the disclosure. The block diagram 500a may be implemented at least partially by a computer system that includes a computer server 300 illustrated in FIG. 3. The computer implemented method according to the example block diagram 500a includes the following acts. Other acts may be added or substituted.

In act 510, the computer system records campaign data during a first time period in a database. The campaign data may include a number of cumulative impressions of a recent campaign, conversion history of the recent campaign, and CPM of each placement in an upcoming campaign. The campaign data may include other information such as conversion time, delays between two consecutive impressions, delays between two consecutive conversions, and other parameters related to impressions and conversions.

The computer system may record campaign data continuously. For example, the computer system may record any impression and conversion when it happens. The recording, however, may only be recorded in the terminal devices when the action happens. The recording may need to be transmitted to a server computer so that the server computer can record the activities in the database. The computer system may update the database hourly or daily during off-peak times so that the database can be accessed by servers for other purposes during peak times.

In act 520, the computer system receives a budget to be spent on a plurality of placements during a second time period. A placement may include a plurality of websites or platforms in some cases. A placement may only include one website or mobile application in other cases. The budget may include one total budget for all placements. The advertiser may put additional constraints for the budget. For example, one additional constraint may include at least one of an upper limit and a lower limit to be spent in a month for at least one of the placements. Another example of additional constraint may include a lower limit or an upper limit of the number of impressions to be bought on at least one of the placements. The budget may also be a fixed amount to be spent each day in a preset period of time. The budget may vary from day to day depending on whether it is a business day or a holiday as long as it is fixed for each period of time during the campaign. The budget may also increase linearly or nonlinearly from the beginning of the campaign to the end of the campaign. The advertiser may select or draw a curve on the user interface to allocate the budget for each time period during the whole campaign. For example, the computer system may display a user interface that shows a grid over a month, the advertiser may then input the budget amount on each day by moving a gauge for each day of the month. The computer system may further enable the advertiser to set an upper limit and lower limit on the daily budget on each day.

In act 530, the computer system obtains a non-linear model based on the campaign data. The non-linear model may have one or more parameters that need to be estimated using the historical campaign data recorded in the database. For example, the non-linear model may estimate a reach per website as a polynomial function C^{α} using the non-linear model, where C is a cumulative number of impressions and a is the estimated parameter for the non-linear model. The parameter a may be restricted to be a positive number. The parameter a may further be restricted to be greater than zero and less than or equal to one. Other non-linear models may also be used.

In act 540, the computer system estimates an expected number of conversions during the second time period for each of the plurality of placements using the non-linear model. The second time period may be the next day or the next month depending on system settings and/or advertiser preferences.

In act 550, the computer system allocates the budget to the plurality of placements that maximizes an estimated total number of conversions from the plurality of placements. The computer system is programmed to formulate the allocation problem into a convex optimization problem based on the estimated model parameters. Accordingly, the convex optimization problem may then be solved using software packages in computer servers to maximize a concave objective function, which is the total number of conversions in the next time period.

In act 560, the computer system displays the budget and the estimated total number of conversions on a computer screen for the advertisers. For example, the computer system may display a single result based on fixed amount of budget and fixed number of websites and/or platforms. Alternatively or additionally, the computer system may display comparisons for different scenarios if the advertiser allows the computer system to perform the above acts using a flexible number of websites and/or platforms. For example, the computer system may enable the advertisers to compare the different conversion estimations of advertising on 5 websites and 10 websites with the same amount of budget. The computer system may enable the advertisers to compare different conversion estimations with a $400,000 on 10 websites and $600,000 on 12 websites. The computer system may show those different estimations so that the advertiser can make a more informed decision.

The above acts may be repeated to get more conversions. For example, the acts may be repeated for each day or each week to update the allocation of the budget during each day or each week.

FIG. 5B is an example block diagram 500b illustrating embodiments of the disclosure. The acts in the example block diagram 500b may be combined with the acts in the block diagram 500a shown in FIG. 5A. Similarly, the acts in block diagram 500b may be implemented at least partially by a computer system that includes a server 300 disclosed in FIG. 3. The computer implemented method according to the example block diagram 500b includes the following acts. Other acts may be added or substituted.

In act 532, the computer system estimates a parameter for the non-linear model based on the campaign data using regression analysis. This act may be included in act 530 in FIG. 5A. Generally, the regression analysis is a statistical process for estimating the relationships among different parameters of the non-linear model. For example, the computer system may use a minimum mean square error (MMSE) estimator that minimizes the mean square error (MSE) of the fitted values of a dependent variable.

In act 542, the computer system estimates a reach per placement as a polynomial function C^{α} using the non-linear model, where C is a cumulative number of impressions and a is the estimated parameter for the non-linear model. The computer system may estimate a reach for each website or placements in one or more placements. The computer system may estimates a reach per website or placement using a rational function such as β(C/(C+λ)), in which there are two parameters β and λ which need to be estimated using regression analysis or other analysis. When the MMSE estimator is used, the exponent a is the one that achieves the minimum square error. This act may be included in act 540 in FIG. 5A.

In act 545, the computer system estimates the expected number of conversions for each of the plurality of placements as b*X^{α}, where b is a normalization factor, X is a number of impressions to be purchased, and α is the estimated parameter for the non-linear model. Alternatively, the computer system may estimate the expected number of conversions for each of the plurality of placements as b*(X/(X+λ)), where X is the number of impressions to be purchased, and b and λ are the estimated parameters. This act may follow the act 570 in FIG. 5A.

In act 555, the computer system determines the allocation of impressions using convex optimization that maximizes

$${\sum }_{1}^{N} {b}_{i} {X}_{i}^{{α}_{i}} ,$$

where bᵢ is a normalization factor for each placement, Xᵢ is a number of impressions to be purchased for each placement, αᵢ is the estimated parameter for the non-linear model for each placement, and N is a total number of placements of the plurality of placements. Note that the target function to be maximized may have other explicit expressions. For example, when the non-linear model estimates the expected number of conversions as b*(X/(X+λ)), the computer system determines the allocation of impressions using convex optimization that maximizes the target function of

$${\sum }_{1}^{N} {b}_{i} {X}_{i}^{{α}_{i}} , {\sum }_{1}^{N} {b}_{i} {X}_{i} \text{/} ( {X}_{i} + {λ}_{i} ) .$$

If the advertiser selects only one website for each placement, N is the total number of websites. The computer system is also programmed to keep an actual budget less than or equal to the budget to be spent in total on the plurality of placements during the specific time period. This act may be performed during the act 550 in FIG. 5A.

In act 565, the computer system determines a number of credits for each placement using a simulator based on inverse-propensity weighting. The simulator may include a Multi-Touch Attribution (MTA) model. More details about the simulator may be found in U.S. Patent Publication No. 2013/0085868 A1. This act may follow each conversion is recorded or at the end of each billing circle to the advertisers. This act may also be performed following the act 560 in FIG. 5A.

The act 565 may also include additional steps using the MTA model or other models. For example, the computer system may first break down the effects of each placement by splitting each of the successes according to the number of impressions the user is exposed to, and hence each of the placements gets a partial credit for the success. Second, the computer system may compare the success rates of the exposed and control groups to get the lift of success rate resulting from advertising. The computer system then computes the ratio of the success rate lift to the success rate of the exposed group, which is applied to adjust the cumulative probability of success for each placement.

Once the likelihood of success for each placement and impression level is identified, the computer system may compute the success credit allocation for each successful user using the following calculations:

Placement 1 Credit=(Placement 1 likelihood at x# ads)/[(Placement 1 likelihood at x# ads)+(Placement 2 likelihood at x# ads)].

Placement 2 Credit=(Placement 2 likelihood at x# ads)/[(Placement 1 likelihood at x# ads)+(Placement 2 likelihood at x# ads)].

(Placement p# likelihood at x# ads) may be calculated in two ways:

1) ‘placement p# likelihood at x# ads’ equals to the cumulative probability of success for corresponding placement and frequency. This approach utilizes the observed success rates of each placement as an estimation of the ad effectiveness of this placement.

2) ‘placement p# likelihood at x# ads’ is calculated as the cumulative probability of success for corresponding placement and frequency times the lift ratio of the corresponding placement. This approach utilizes the lift of the success rates of each placement comparing to the corresponding control group as an estimation of the ad effectiveness of this placement.

Finally, the computer server allocates the sum of the above calculations as the total credit to each placement. In short, the credit the simulator assigns a placement for a single success is equal to the likelihood that the person would succeed after exposure to the number of ads he/she saw on that particular placement, divided by the summation of the probabilities of success from all exposures the person received. For example, if a user's likelihood to succeed after exposure to a placement was 0.05, and their likelihood to succeed from all exposures was 0.1, the placement in question would receive ½ the credit for that success.

In the embodiments, there are a total of K placements, which may belong to one or more placements. There are two different campaign plans. The first one relates to the observed campaign data stored in the database, which are used for model training (training campaign, indicated by superscript T). The other campaign is an alternative campaign plan that happens in the future (forecast campaign, indicated by superscript F).

For the training campaign, each placement k has the following parameters calculated and stored in a database.

(a) The number of impressions shown on that placement.

(b) The number of reached unique users Aₖ^{T}, which is the estimated number of reached unique users of placement k. It may also be referred to as the number of audience of placement k.

(c) Jₖ^{T}, which is the estimated average number of impressions per user of placement k, calculated according to the number of audience 4.

(d) Cₖ^{T}, the calculated credit of placement k.

(e) A function hₖ(j), the success rate among users who have seen exactly j ads on placement k.

(f) Exposed success rate Rₖ^{exp} and control success rate Rₖ^{ctrl}. The control success rate indicates the portion of people who made the purchase even without being exposed to the campaign.

For the forecast campaign, each of the placement k has the following input statistics, which may need to be determined based on the non-linear model trained using the training campaign parameters.

(a) Budget ranges, which may include upper and lower limits for the placement.

(b) The estimated number of reached unique users Aₖ^{F}, which is a function of the number Xₖ of impressions to be bought on placement k. It may also be referred to as the number of audience of placement k.

(c) Jₖ^{F}, which is the estimated average number of impressions per user of placement k, which may be calculated as the number Xₖ divided by the reach Aₖ^{F} of placement k.

To calculate the forecasted total (not incremental) number of conversions, the computer server may use the following equation to obtain the calculated total credit Cₖ^{F,total} placement k.

Cₖ^{F,total}=[Cₖ^{T}/Aₖ^{T}+(hₖ(Jₖ^{F})−hₖ(Jₖ^{T})(Rₖ^{exp}−Rₖ^{ctrl})/Rₖ^{exp}]Aₖ^{F}

The computer server may then calculate the total number of conversions C^{F,total} by adding the obtained credit from each placement k, where C^{F,total}=Σₖ₌₁^{K}Cₖ^{F,total}.

For the forecast campaign, the computer server may use the following equation to calculate the following out statistics for each of the placement k. The computer server may obtain the calculated incremental credit Cₖ^{F,incre} of placement k.

Cₖ^{F,incre}={[Cₖ^{T}/Aₖ^{T}+(hₖ(Jₖ^{F})−hₖ(Jₖ^{T})](Rₖ^{exp}−Rₖ^{ctrl})/Rₖ^{exp}}Aₖ^{F}, which is a function of the number Xₖ of impressions bought on placement k. In the formula, Jₖ^{F} and Aₖ^{F} are functions of Xₖ. Thus, Cₖ^{F,incre} is a function of Xₖ and may be written as Cₖ^{F,incre} (Xₖ), which may be approximated using a simple function such as a polynomial function or a rational function disclosed above. For example, the function Cₖ^{F,incre} (Xₖ) may be approximated by bₖXₖ/(Xₖ+λₖ), where bₖ and λₖ are parameters to be estimated using data from the training campaigns.

The computer server may then calculate the incremental number of conversions C^{F,incre} by adding the obtained credit from each placement k, where C^{F,incre}=Σₖ₌₁^{K}Cₖ^{F,incre}. Accordingly, the target function to be maximized is the number of incremental conversions, which is C^{F,incre}=Σₖ₌₁^{K}Cₖ^{F,incre}(Xₖ). The target function may be approximated by Σₖ₌₁^{K}bₖXₖ/(Xₖ+λₖ). If the cost of one impression on placement k is pₖ, then the actual optimization problem P is to maximize Σₖ₌₁^{K}bₖXₖ/(Xₖ+λₖ) subject to Σₖ₌₁^{K}pₖXₖ≦B. The constraint condition indicates that the total to be spent cannot be more dollars than the B dollars, which is the specified budget of the advertiser. In addition, a user or a computer server may specify lower and upper bounds on each Xₖ as additional constraint conditions for the optimization problem. Accordingly, because the polynomial functions and the rational functions are concave functions, so is the sum of such functions. And the constraint function is a linear constraint. Thus, this problem is to maximize a concave target function and hence may be solved by convex programming. Note that the convex programming and approximation functions are only for illustration only and there may be other ways to maximize the number of conversions.

Note that the “success” rate may be different in the future campaign. Jₖ^{F} is the average number of impressions on placement k to be seen by a random user in the future campaign, which is the total (to be determined) number of impressions to be bought on placement k, divided by the predicted reach on placement k. For example, if we used Xₖ to be the number of impressions to be bought on placement k, and we estimated the reach in placement k to be a function f(Xₖ), then the ratio Xₖ^{T}/Aₖ^{T} would be Xₖ/f(Xₖ). Here, the function f(Xₖ) may be a polynomial function or a rational function disclosed above.

In the above equations, hₖ(y) indicates the success rate for people who have seen an average of y ads. Hence, if Jₖ^{F} is the average number of ads on placement k to be seen by a person, hₖ(Jₖ^{F}) is the average success rate to be expected in the future campaign. Similarly, hₖ(Jₖ^{T}) is the average success rate that was experienced in the past campaign. This makes the difference, namely, hₖ(Jₖ^{F})−hₖ(Jₖ^{T}), a correction term, which indicates the change in success rate that will be due to changing the number of impressions from the past campaign to the future campaign. In other words, the first term Cₖ^{T}/Aₖ^{T} is the credit allocated to placement k, per person who saw at least one ad, in the past campaign, and the second term hₖ(Jₖ^{F})−hₖ(Jₖ^{T}) is the correction due to buying a different number of impressions in the future from the past.

The disclosed computer implemented method may be stored in computer-readable storage medium. The computer-readable storage medium is accessible to at least one hardware processor. The processor is configured to implement the stored instructions to select a target audience based on extracted features from the user data and the advertiser input.

From the foregoing, it can be seen that the present embodiments provide a computer system that includes two major steps. First, the computer system trains a non-linear model that can be used to estimate the number of conversions for different websites and platforms. Second, the computer system formulates a convex target function that maximizes the expected number of conversions on the different websites and platforms.

The disclosed system offers the advertiser a budget allocation solution so that the advertisers spend their budget more effectively. The computer system may provide comparison results when the advertiser chooses different budgets or different number of websites and platforms for their campaigns.

It is therefore intended that the foregoing detailed description be regarded as illustrative rather than limiting, and that it be understood that it is the following claims, including all equivalents, that are intended to define the spirit and scope of this invention.

What is claimed is:

1. A system comprising a processor and a non-transitory storage medium accessible to the processor, the system comprising:
a memory storing a database comprising campaign data;
a server computer in communication with the database, the server computer programmed to:
receive a budget to be spent on a plurality of websites;
estimate a parameter for a non-linear model based on the campaign data;
estimate an expected number of conversions for each of the plurality of websites using the non-linear model with the estimated parameter; and
determine an allocation of impressions for the plurality of websites that maximizes an estimated total number of conversions.

2. The system of claim 1, wherein the campaign data comprises a number of cumulative impressions of a recent campaign, conversion history of the recent campaign, and cost per mille (CPM) of an upcoming campaign.

3. The system of claim 1, wherein the server computer is programmed to estimate the parameter for the non-linear model based on the campaign data using regression analysis.

4. The system of claim 1, wherein the server computer is programmed to estimate a reach per website as a polynomial function C^{α} using the non-linear model, where C is a cumulative number of impressions and α is the estimated parameter for the non-linear model.

5. The system of claim 1, wherein the server computer is programmed to determine a number of credits for each website using a simulator based on inverse-propensity weighting.

6. The system of claim 1, wherein the server computer is programmed to estimate the expected number of conversions for each of the plurality of websites as b*X^{α}, where b is a normalization factor, X is a number of impressions to be purchased, and a is the estimated parameter for the non-linear model.

7. The system of claim 1, wherein the server computer is programmed to determine the allocation of impressions using convex optimization that maximizes
$${\sum }_{1}^{N} {b}_{i} {X}_{i}^{{α}_{i}} ,$$
where bᵢ is a normalization factor for each website, Xᵢ is a number of impressions to be purchased for each website, αᵢ is the estimated parameter for the non-linear model for each website, and N is a total number of websites of the plurality of websites.

8. The system of claim 7, wherein the server computer is programmed to determine the allocation of impressions using convex optimization that maximizes
$${\sum }_{1}^{N} {b}_{i} {X}_{i}^{{α}_{i}}$$
while keeping an actual budget less than or equal to the budget available to be spent on the plurality of websites.

9. A method, comprising:
recording campaign data during a first time period in a database;
receiving, by one or more devices having a processor, a budget to be spent on a plurality of placements during a second time period;
obtaining, by the one or more devices, a non-linear model based on the campaign data;
estimating, by the one or more devices, an expected number of conversions during the second time period for each of the plurality of placements using the non-linear model; and
allocating, by the one or more devices, the budget to the plurality of placements that maximizes an estimated total number of conversions from the plurality of placements.

10. The method of claim 9, wherein recording campaign data in the database comprises recording the campaign data comprising:
a number of cumulative impressions of a recent campaign, conversion history of the recent campaign, and cost per mille (CPM) of each placement in an upcoming campaign.

11. The method of claim 9, further comprising:
estimating, by the one or more devices, at least one parameter for the non-linear model based on the campaign data using regression analysis.

12. The method of claim 9, further comprising:
estimating, by the one or more devices, a reach per placement as a rational function β(C/(C+λ)) using the non-linear model, where C is a cumulative number of impressions and β and λ are parameters for the non-linear model.

13. The method of claim 9, further comprising:
determining, by the one or more devices, a number of credits for each placement using a simulator based on inverse-propensity weighting.

14. The method of claim 9, further comprising:
estimating, by the one or more devices, the expected number of conversions for each of the plurality of placements as b*(X/(X+λ)), where b is a normalization factor, X is a number of impressions to be purchased, and, and b and λ are the parameters to be estimated using regression analysis for the non-linear model.

15. The method of claim 9, wherein allocating the budget to the plurality of placements comprises:
determining, by the one or more devices, the allocation of impressions using convex optimization that maximizes
$${\sum }_{1}^{N} {b}_{i} {X}_{i} \text{/} ( {X}_{i} + {λ}_{i} ) ,$$
where bᵢ is a normalization factor for each placement, Xᵢ is a number of impressions to be purchased for each placement in each placement, λᵢ is the estimated parameter for the non-linear model for each placement, and N is a total number of placements of the plurality of placements.

16. The method of claim 15, wherein allocating the budget to the plurality of placements comprises:
determining, by the one or more devices, the allocation of impressions using convex optimization that maximizes
$${\sum }_{1}^{N} {b}_{i} {X}_{i} \text{/} ( {X}_{i} + {λ}_{i} )$$
while keeping an actual budget less than or equal to the budget available to be spent in total on the plurality of placements.

17. A non-transitory storage medium configured to store modules comprising:
module for recording campaign data in a database, the campaign data comprising: a number of cumulative impressions of a recent campaign and conversion history of the recent campaign;
module for receiving a budget to be spent on a plurality of future campaigns;
module for estimating at least one parameter for a non-linear model based on the campaign data;
module for estimating an expected number of conversions for each of the plurality of future campaigns using the non-linear model with the at least one estimated parameter; and
module for determining an allocation of impressions for the plurality of future campaigns that maximizes an estimated total number of conversions from the plurality of future campaigns.

18. The non-transitory storage medium of claim 17, wherein the modules comprise:
module for estimating the at least one parameter for the non-linear model based on the campaign data using regression analysis; and
module for estimating a reach per future campaign as a polynomial function C^{α} using the non-linear model, where C is the cumulative number of impressions and α is the estimated parameter for the non-linear model.

19. The non-transitory storage medium of claim 17, wherein the modules comprise:
module for estimating the expected number of conversions for each of the plurality of future campaigns as b*X^{α}, where b is a normalization factor, X is a number of impressions to be purchased, and a is the estimated parameter for the non-linear model.

20. The non-transitory storage medium of claim 17 wherein the modules comprise:
module for determining the allocation of impressions using convex optimization that maximizes Σₖ₌₁^{K}bₖXₖ/(Xₖ+λₖ) while keeping an actual expenditure Σₖ₌₁^{K}pₖXₖ less than or equal to the budget available to be spent on the plurality of future campaigns, where Xₖ is a number of impressions to be purchased for website k, bₖ and λₖ are estimated parameters for website k, and K is a total number of websites of the plurality of future campaigns.
